(19) United States
(12) Patent Application Publication
(10) Pub. No.: US 2008/0178011 A1
(43) Pub. Date: Jul. 24, 2008

(54) METHOD AND APPARATUS FOR USB/OTG CONNECTION PROVIDING ACTIVE HNP REQUESTS AND SAVING HOST POWER

(75) Inventors: Michael Hubo, Hattingen (DE); Achim van Bebber, Bochum (DE)

Correspondence Address: MORGAN & FINNEGAN, L.L.P., 3 WORLD FINANCIAL CENTER, NEW YORK, NY, 10281-2101, US

(73) Assignee: NOKIA CORPORATION, Espoo (FI)

(21) Appl. No.: 11/624,434

(22) Filed: Jan. 18, 2007

(51) Int. Cl. G06F 1/00

(52) U.S. Cl. 713/300

(57) ABSTRACT

A method and apparatus are disclosed for connecting USB devices in a USB connection to save power and enable role changes between the USB devices in a USB-OTG connection, while the USB devices are in an active state wherein an A-Device informs a B-device, that the A-Device will lower the Vbus-signal to a lower voltage level (e.g. 3.3V), provided the A-Device has recognized that the B-Device supports SRP and HNP. The lowered voltage level enables the A-Device to save the power. The lowered Vbus level now allows the B-Device to raise the Vbus voltage to 5V, which is detected on the A-Device. Whenever the A-Device recognizes, that the B-device has raised Vbus to 5V, the A device interprets this as a request of the B-device to gain the host role. The A-Device suspends the USB-Bus at the earliest possible time to allow the B-Device to perform HNP, and assume the role as host.

### BACKGROUND OF INVENTION

1. Field of Invention

This invention relates to communication interfaces for connecting host devices and peripheral devices to each other for the transfer of information. More particularly, the invention relates to a method and apparatus for a Universal Serial Bus (USB) On-the-Go (OTG) connection initiating switching of host and peripheral roles while the host device is in an active state and achieving power savings for both host and device.

2. Description of Prior Art

The OTG Supplement to the USB 2.0 Specification defines that the OTG-Device with the A-Plug inserted is the default Host (A Device). The OTG-Device with the B-Plug inserted is the default Peripheral Device (B Device). The A and B devices are joined together by a cable including a Voltage Bus (V_{B}); Data Lines (D+), (D−); Ground (GND), and ID Detect. The OTG Supplement provides the A and B devices can switch roles whereas the USB Specification 2.0 does not provide for role switching. However, the OTG Specification provides the B-Device can only gain the A or Host-Role, if the A-Device has stopped using and suspends the Bus, but the B device cannot actively request to become the Host, while the A-Device is in active state using the Bus. Also, the A-Device can turn off V_{B} when it is no longer using the Bus to save power, if the remote B device supports Session Request Protocol (SRP), but this does not optimize the power consumption during the time of the bus-usage.

Related art implementing the OTG Supplement includes:

USPAP 2006/0075152 to Xiaoming Zhu, published Apr. 6, 2006, filed Sep. 20, 2004 discloses an apparatus for detection of a USB host or a USB OTG device being attached to Vbus connector terminal of a USB device. The apparatus includes an attach detection pull down resistor isolated from the Vbuus connector terminal. The attach detection feature guarantees USB attach detection and complies with current limits of both USB 1.1 and USB 2.0 OTG specifications.

USPAP 2006/0076977 to Xiaoming Zhu, published Apr. 13, 2006, filed Sep. 20, 2004 discloses a USB 1.1 device and a USB 1.1 host communicate seamlessly with a USB OTG device. The USB 1.1 host, USB 1.1 device and mixed signal circuits implement USB OTG functions. The mixed signal components are controlled by the USB 1.1 device microcontroller.

None of the related art describes or suggests a method and apparatus modifying the role switching method of the OTG Supplement to the USB 2.0 Specification by (a) an A device in active state, sending a message to a B device that Vbus will be lowered, while the A devices continues in an active state with B device; (b) the B device restoring the Vbus level as a signal to the A device that it wishes to role switch; (c) the A device recognizing the restored Vbus level as a request by the B device to assume the host role; (d) the A device suspending the bus, and (e) the B device executing HNP to become the A device while the A device becomes the B device, which is not achieved in the prior art and saves power.

### SUMMARY OF INVENTION

What is needed in the art is a method and apparatus enabling an A device during an active connection to send a USB Request Message informing the B device that Vb will be lowered to save power. The lowered Vb serves as a signal to the B device to initiate role switching by raising and restoring the Vb voltage level and implementing a Host Negotiation Protocol (HNP), after the A device suspends the bus at the earliest possible time.

A host device, typically an intelligent network, e.g. a processor exchanges data with a peripheral device, typically a data source or sink. The host and peripheral device are coupled together via a universal series bus (USB) cable including a plug at each end or with a captive cable which is fixed to an apparatus and has a connector only on one end (e.g. USB mouse). One plug services the host as the A device. The other plug services the peripheral device as the B device. The cable includes a voltage bus Vb providing power from the A device to the B device; a data line D+, a data line D− for data transfer, a ground line, and an optional ID line. Data is exchanged over the cable, according to the On-The-Go Supplement to the USB 2.0 specification, which provides for the A and B devices to exchange roles after the host stops using and suspends the bus. In the present invention, the B device is enabled to switch roles with the A device while the A device is in an active state by the A device sending a Request Message informing the B device the voltage bus will be lowered from 5 volts to e.g. 3.3 volts. The A device continues to send data over the bus after the bus voltage is lowered to e.g. 3.3 V. The B device raises the bus voltage back to 5 volts as a signal to the A device that the B device desires to serve as the host. The bus is suspended by the A-device after the A-device stops using the bus. The B device initiates a Host Negotiation Protocol available under the USB 2.0 specification and assumes the role as the host device while the host or A device assumes the role as the B device. The lowering of the voltage level from 5.0 V to 3.3 V while the A device serves as the host saves power in both devices. The ability of the B device to change roles while the A device is active host provides additional functionality to the USB On The Go standard.

While the 5.0 V level is fixed according to the USB standard, the second voltage level can be any voltage that is distinguishably lower than 5.0 V. For example, the second voltage level could also be e.g. 1.8V, 2.5 V or 4.0 V.

In addition to lowering Vbus, the signaling voltage on the data lines D+ and D− may also be lowered, preferably to the same level asVbus.

A feature of the invention is a method and apparatus providing additional functionality and power savings for the USB OTG standard.

Another feature is a Request Message generated and transmitted by an A device in a USB connection to a B device informing the B device of a lowered Vbus voltage level for power savings.

Another feature is A and B devices in an OTG USB connection switching roles while the A device is in an active state.

Another feature is a B device in a USB OTG connection restoring Vbus voltage level after lowering by an A device, as a signal to the A device of the B device intention to assume the role of host.

Another feature is an A device in a USB OTG connection recognizing a restored Vbus voltage level as a signal that a B device is seeking to gain the host role.

Another feature is a USB connection saving power by lowering Vbus while an A device is in an active state.

### DESCRIPTION OF DRAWINGS

The invention will be further apprehended from the following description of a Preferred Embodiment, taken in conjunction with an appended drawing, in which:

FIG. 1 is a representation of a USB OTG connection between a Host or A device and a Peripheral or B device for transferring information from the host to the B device and incorporating the principles of the present invention;

FIG. 2 is a representation of a “set_Request” Message generated and transmitted by the A device to the B device of FIG. 1 informing the B device that Vbus will be lowered from 5.0 volts to 3.3 volts for power savings;

FIG. 3 is a message sequence in a process establishing a USB OTG connection between a Host or A device and a peripheral or B device, shown in FIG. 1 enabling the A and B devices to exchange roles and save host power requirements while the A device is in an active state;

FIG. 3A is a graph of Vbus versus time wherein the Vbus voltage is lowered at a first time (T3) to save power and the Vbus voltage level is restored at a second time (T4) signaling the A device that the B device desires to assume the host role;

FIG. 3B is a flow diagram of the A device operation in the process of FIG. 3; and

FIG. 3C is a flow diagram of the B device operation in the process of FIG. 3.

### DESCRIPTION OF PREFERRED EMBODIMENT

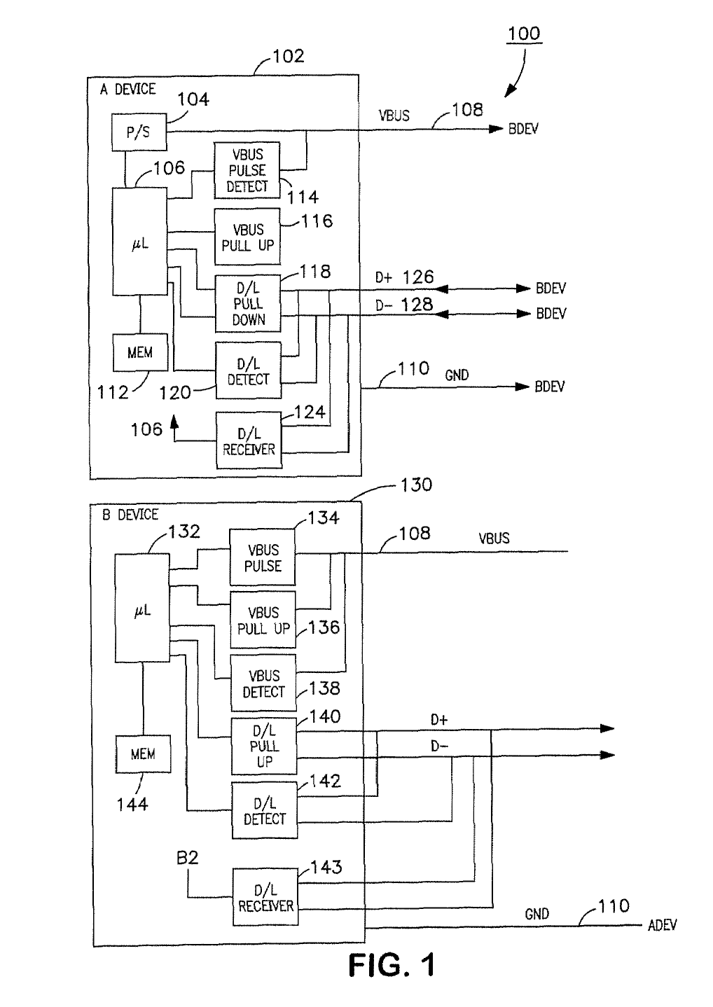

FIG. 1 discloses a Universal Series (USB) 2.0 system 100 that supports data exchanges between a host or A device 102 and a wide range of simultaneously accessible peripherals or B devices 130. The host functions as a master device and the peripheral functions as a slave device in data exchanges. A role change is not provided by the USB 2.0 standard. However, a supplement to the USB 2.0 standard is a USB On-The-Go (OTG) protocol which enables host and peripheral devices to exchange roles, where the host serves as a peripheral and the peripheral serves as the host for data exchanges. Both the USB 2.0 standard and OTG Supplement are fully incorporated herein by reference. In the present instance, the A device 102 should be a USB-OTG device, or dual role device, whereas the B device 130 may be either a dual role device or a non-OTG device. For example, a headset could be B device that never could be an A device, but yet is within the scope of the invention.

The A device 102 comprises a power supply 104 managed by a micro controller 106 for activating or powering down a Vbus 108 between 5.0 volts and e.g. 3.3 volts relative to a ground line 110 or stopping or providing power on the bus, according to commands or standard requests stored in a memory 112 . The requests are processed by the micro controller and further described in the USB 2.0 specification, Chapter 10. The memory 112 includes software executed by the micro controller for managing interactions between USB devices and host based software according to the USB 2.0 Specification, Chapter 5.

Vbus pulse detect block 114 controlled by the micro controller 106 is coupled to the Vbus line 108 and detects signaling from the B-device to denote a Session Request Protocol (SRP). A Session Request Protocol allows a B device to request the A device to turn on the Vbus and start a data exchange session.

Vbus pulsing circuit 134 in the B-device 130 is controlled by a microcontroller 132 and coupled to theVbus 108. The circuit 134 when operated, signals the A device that the B device is Vbus pulsing for a valid SRP request.

Returning to the A device, dataline pull up/down circuit 118 is controlled by the micro controller 106 and coupled to a D+ data line 126 and D− data line 128 for pull up or pull down for differential transfer of data between the A and B devices or disablement of the data lines, respectively under the control of the micro controller 106.

Dataline pulsing detect circuit 120 is controlled by the microcontroller and coupled to the D+ 126 and to D− 128 for detecting SRP with the A device by the B device.

Dataline receivers 124 are coupled to the D+ and D− lines for the transfer of data between the A device and B device for storage in the memory 112 under the control of the micro controller.

Turning to the B device 130, an interface is presented to the A device and is responsive to the USB protocols and operations, such as configuration, reset and descriptor information of the B devices capability. The B device includes a micro controller 132 coupled to the Vbus pulsing circuit 134; Vbus pull-up 136; Vbus detect 138; dataline pull up/down 140; dataline detect 142 and dataline receiver 143 all controlled by the micro controller 132. A memory 144 services the microcontroller. The B device circuits mirror the A device circuits. The Vbus and dataline circuits are conventional and well known in the USB prior art.

The B device transfers data with the A device before or after a SRP. The SRP allows the B device to request the A device to turn on the Vbus and start a session. Two methods are available for the B device to request the A device to begin a session. The session methods are Vbus pulsing and dataline pulsing, as described in the OTG supplement Section 5.3.

A session is defined as a period of time that the Vbus voltage is above is the session valid threshold of a given device. The A device threshold should be within a range of 5.0-4.4 volts. While the B threshold should be in the range of 4.0-0.8 volts. At the start of a session the A device defaults to the role as host. The role of host can be transferred back and forth between the A device and the B device any number of times using a Host Negotiation Protocol (HNP). The session ends when the Vbus falls below the A device session valid threshold of 4.0-0.8 volts. The details of the HNP are described in the “On-The-Go Supplement to the USB 2.0 Specification”, Revision 1.0a, Jun. 24, 2003, pages 50-52, as described below in Paragraphs 0031-0038.

To initiate a request a new session using dataline pulsing, the B device waits until the initial conditions are met and turns on its dataline pull up circuit 140 (See FIG. 1) (either D+ or D− for a period 5 to 10 microseconds). The time length of such a dataline pulse is sufficient to allow the A device to reject various voltage transients on the dataline. The A device is designed to detect dataline pulsing and generate a SRP indication if either D+ goes high or D− goes high.

To indicate a request for a new session using Vbus pulsing, the B device waits until the initial conditions are met previously described and then pulses Vbus using circuit 134 (FIG. 1) The Vbus pulsing is driven for a period time that is long enough for a capacitance (not shown) on Vbus to charge. There are two scenarios that a B device can encounter when it is pulsing Vbus to initiate SRP. In one scenario, the B device is connected to an A device that responds to the Vbus pulsing SRP. In this case, the B device can drive Vbus above the A device session valid threshold in order to wake up the A device. When driving such an A device, the B device shall insure that the lower Vbus goes above 2.1 volt but does not exceed 5.25 volt.

In the second scenario, the B device is attached to a standard host. In this case the B device does not drive Vbus above 2.0 volts. This ensures that no damage is done to standard hosts that are not designed to withstand a voltage externally applied to the Vbus.

To transfer control between a B device and A device, a Host Negotiation Protocol (HNP) is used. This is accomplished by having the A device condition the B device to be able take control of the Vbus when an opportunity is presented for the B device to take control.

The B device is conditioned when the A device sends a Set Feature command which enables a B device to perform certain behaviors or to indicate certain capabilities to the A device. Set Feature commands are described in the OTG Supplement, Chapter 6. Any HNP capable device is required to accept the Set Feature command for this feature. If the device is not HNP capable the device shall return STALL.

After sending the Set feature command, the A device may suspend the Vbus to signal the B device that it may take control of theVbus. If the B device desires to use the Vbus at that time, the B device signals a disconnect to the A device. If the A device has enabled the B device to become host, than the A device will interpret the disconnect as request of the B device to become host. The A device will complete the hand off by turning on it's pull/up circuit 118 (FIG. 1) on the D+ line. When the B device has finished using theVbus, it starts the process of returning control to the A device by stopping all bus activity and turning on the D+ pull/up circuit 140 (FIG. 1) when the bus is in idle state.

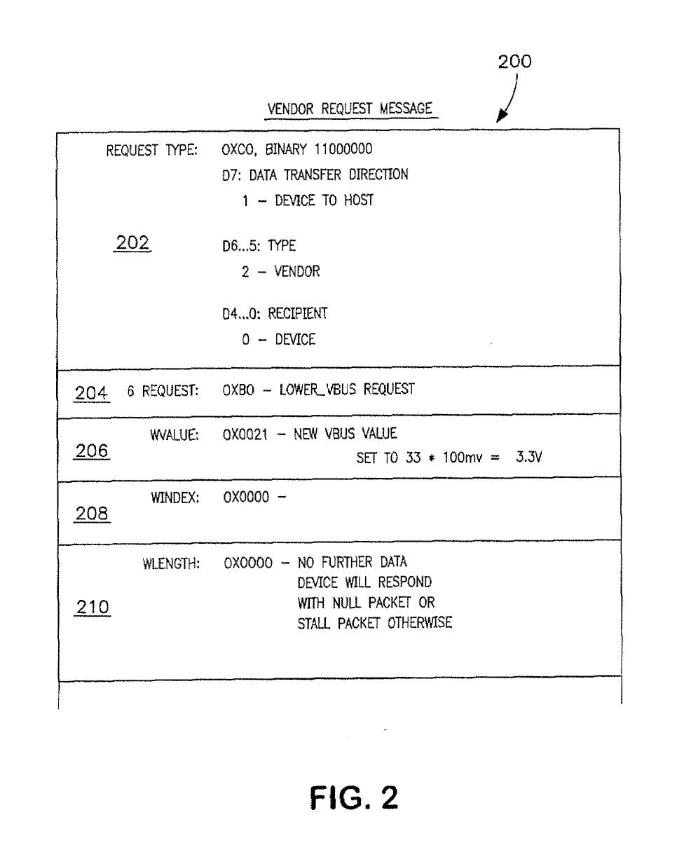

FIG. 2 describes a Standard Device Request 200 enabling an A device to notify a B device which may or may not be capable of SRP and HNP that the Vbus voltage will be lowered from 5.0 to 3.3 volts to save power. Standard Device Requests are described in the USB 2.0 Specification, Chapter 9. The Request comprises eight bytes One byte (bmRequest type) describes the Request type. A second byte (bRequest) describes the specific request. Two bytes (wValue) describe a value of a parameter passed to the device, specific to the request. Two bytes (wlndex) can be used to indicate further parameters. Two bytes (wLength) specify the length of the data transferred during a control transfer.

The Standard Device Request 200 comprises sections 202, 204, 206, 208 and 210. The Request section 202 describes the Request type, identified by the code OXCO, wherein data bit 7 describes the data transfer direction. A 0 bit indicates host-to-device transfer and a 1 bit indicates a device to host transfer. Data bits 6 and 5 indicate four types of transfer, and in the present instance the transfer 2 is a vendor transfer. Data bit 4-0 indicate four types of recipients and in the present instance the device is the recipient.

The Request section 204 contains a request code to indicate (LOWER_Vbus REQUEST), the code may be for example: 0xB0.

The Request section 206 contains a value code which describes a new Vbus parameter (for example 0x0021: set Vbus to 3.3 v). In an exemplary embodiment, the value of the field is read as an integer value (0x0021=33), and the voltage is a multiple of the integer value by 100 mV.

The Request section 208 contains a code 0x0000 for windex which is left blank. Alternatively, this field could be used to indicate the voltage level used on the data lines, e.g. 1.8 v. Coding of this value could be the same as in the wValue field.

The Request section 210 contains a code 0x0000 for wLength which indicates no further data transferred in the data stage, then the B device shall respond with a NULL packet in the status stage, if the device understands the request and accepts it or STALL, otherwise

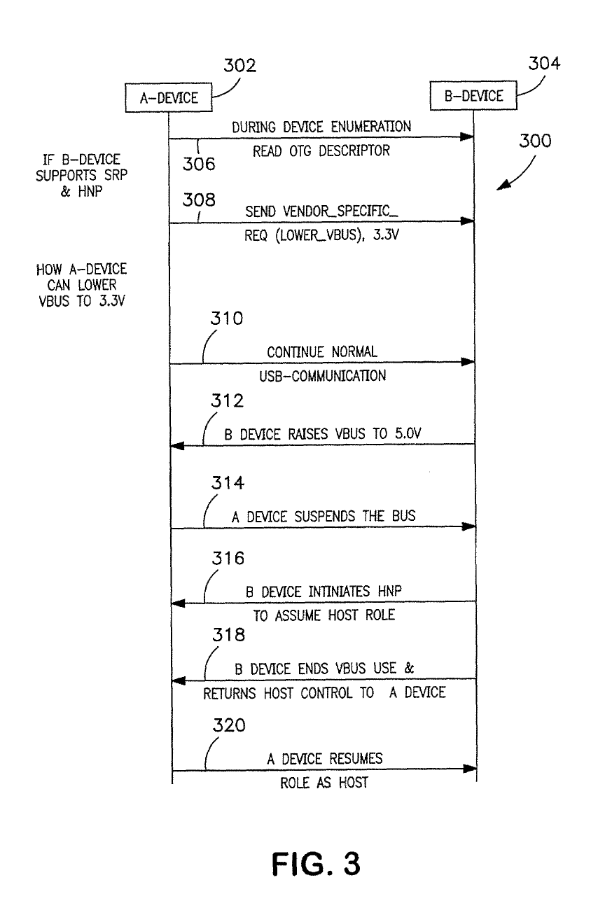

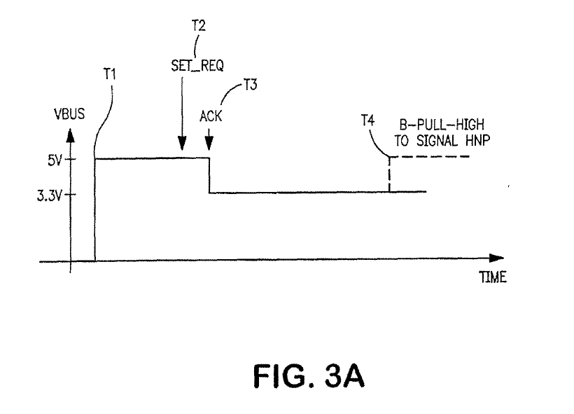

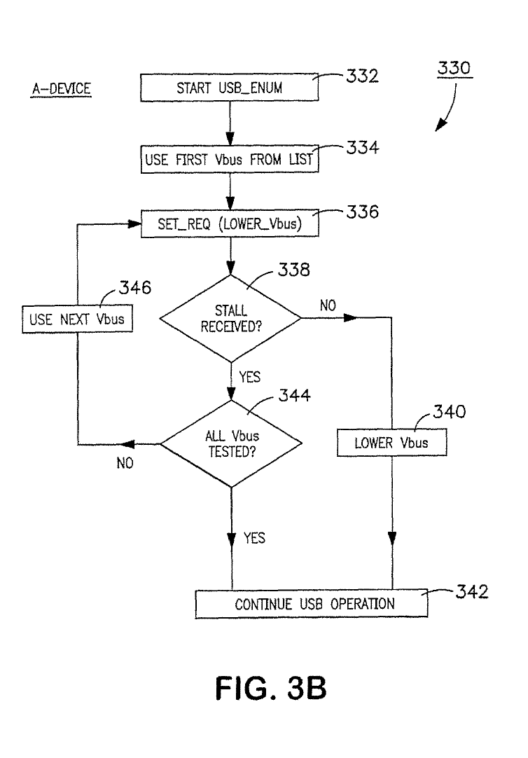

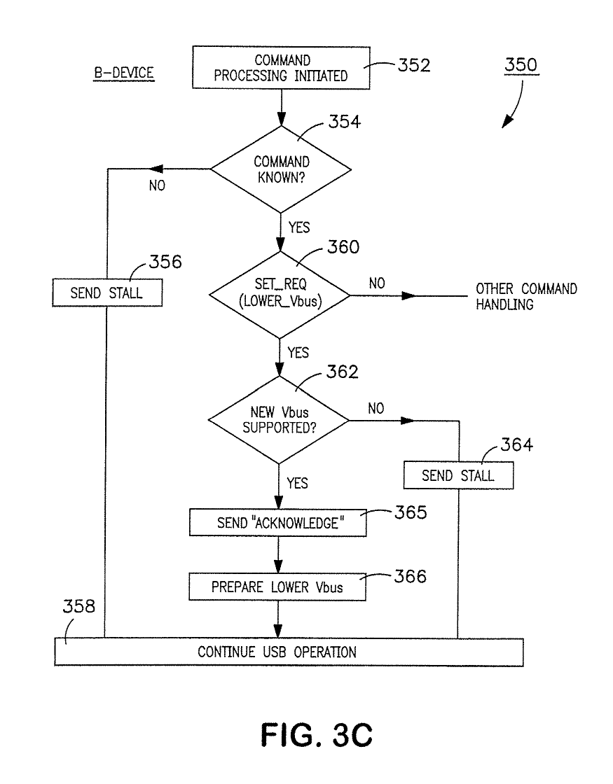

The Vendor Specific Request Message described in FIG. 2 may be used in a process 300, shown in FIG. 3 to initiate power saving and allow the B-device to initiate role switching between an A device 302 and a B device 304 by a series of operations, as follows:

1. Upon detecting the presence of a new B device 304, the A device 302, operation 306, uses a process known as enumeration to identify and manage the B device for data exchanges by assigning a unique address to the B device, after (i) reading the device descriptor describing the device attributes to determine if the B device supports SRP and HNP and (ii) configuring the B device for data transfer, according to the device configuration descriptors.

2. In operation 308, the A device 302 sends the B 304 device a Vendor Specific Request message, e.g. the message 200 shown in FIG. 2, informing the B device that Vbus will be lowered from 5.0 volts to e.g. 3.3 volts. The lowered bus voltage enables the A device to save power for messaging and data transfers. Any B device which does not support the Vendor Specific Request will answer an unsupported request with a STALL response indicating the message is not understood, enabling the A device to detect if the B device can support the lower Vbus voltage.

3. In operation 310, as shown in FIG. 3A, the graph of Vbus versus Time indicates the A device at T1 normally operates Vbus at 5.0 volts. To inform the B device of a lower Vbus level to 3.3 volts, the A device at time T2 sends a “set_Request (LOWER Vbus)” message to the B device . When the B device at time T3 sends an “Acknowledge” response, the A device shortly thereafter lowers Vbus to 3.3 volts, as shown in FIG. 3A. The process continues normal USB communication with the B device at the lower voltage saving power until the B device desires to assume the role of host as will be described in the operation 312.

4. In operation 312, the B device decides to assume the role of host and operates its Vbus pull up circuit to raise Vbus to 5.0 volts, as shown at time T4 in FIG. 3A, which the A device recognizes as a signal that the B device desires to assume the role of host.

5. In operation 314, the A device stops using Vbus at the earliest opportunity and places the bus in a suspend state instead of switching Vbus off. The advantage of lowering Vbus to 3.3 volts instead of completely switching Vbus off enables the B device to detect that the A device is still present. If Vbus was turned off completely, the B device could not tell if the connection was removed or the A device just turned off Vbus.

6. In operation 316, the B device initiates HNP with the A device and assumes the role of host while the A device assumes the role of the B or peripheral device.

7. In operation 318, the B device ends the use of the bus and starts a process of returning control to the A device by stopping all bus activity and turning up its D+ pull up circuit when the bus is idle.

8. In operation 320, the A device will detect the lack of bus activity and turn off its pullup circuit. When the A device detects the connection from the B device, it will resume operation as the host.

The operation of the A and B devices in the process 300 of FIG. 3 is shown in FIGS. 3B and 3C, respectively, as follows;.

In FIG. 3B , a process 330 describes the operation of the A device in the process 300, as follows:

1. USB enumeration is started by the A device in an operation 332.

2. An operation 334 selects the first Vbus in a list of Vbus voltages for a B device.

3. An operation 336 issues a command “set_req (LowerVbus)” to the selected B device.

4. An operation 338 performs a test to determine whether a STALL is received from the B device.

5. A “No” condition for the operation 338 lowers the Vbus in an operation 340 and the USB operation is continued in an operation 342.

6. A “YES” condition for the test 338, initiates a test 344 to determine if all Vbus voltages in the list of Vbus voltages have been tested for the B device.

7. A “NO” condition for the test 344 initiates an operation 346 to select the next Vbus voltages from the list of Vbus voltages for the B device and return to the operation 336.

8. A “YES” condition for the test 344 continues the process in the operation 342.

In FIG. 3C, a process 350 describes the operation of the B device in the process 300, as follows:

1. A command processing is initiated by the B device in an operation 352.

2. A test 354 is performed in an operation 354 to determine if the command is known by the B device.

3. A “NO” condition for the operation 350 initiates a STALL response in an operation 356 and the process 350 continues in an operation 358.

4. A “YES” condition for the test 354 initiates a test 360 to determine if the command is “SET_LOWER_Vbus” request.

5. A “NO” condition for the test 360 activates other B device command handling.

6. A “YES” condition for the test 360 initiates a test 362 to determine if the new Vbus level that was received in the command is supported by the B device.

7. A “NO” condition for the test 362 initiates a STALL response in an operation 364, and the process continues in the operation 358.

8. A “YES” condition for the test 362 sends an acknowledge to the A device in an operation 365.

9. In an operation 366 the B device prepares to lower Vbus, and the process continues in the operation 358.

The process 330 may be modified to include a “get_Request (LOWER₁₃ Vbus)” message at the beginning, i.e. before the “set_Request (LOWER_V bus)” operation 336. In response to the “get_Request (LOWER_Vbus)” message, the B device can respond with a STALL or with the minimum supported Vbus voltage level. The A device would lower the Vbus voltage level to the minimum commonly supported Vbus level of the A and B devices, and the process 330 finishes directly in 342.

While the invention has been described in a preferred embodiment, various modifications can be made therein by those skilled in the art without departing from the scope of the invention.

1. A method comprising:
a) providing a first voltage level via a voltage bus (Vbus) from a first universal series bus (USB) or A device serving as host to a second USB or B device serving as a peripheral device in a USB connection;
b) negotiating a second voltage level on the Vbus that is lower than the first voltage level, and
c) lowering the first voltage level on the Vbus to the second voltage level by the A device to save power on the USB connection.

2. The method of claim 1, wherein the USB connection is a universal series bus-on-the-go (USB-OTG) connection, further comprising:
d) restoring the first voltage level on the Vbus by the B device as a signal to the A device to change roles, where the A device becomes the peripheral device and the B device becomes the host.

3. The method of claim 2 further comprising:
e) exchanging roles by the A and B devices while the devices are in an active state.

4. The method of claim 1, wherein the step of negotiating a second voltage level comprises sending a message to the B device by the A device informing the B device of a proposed lowered Vbus voltage.

5. The method of claim 1, wherein the step of negotiating a second voltage level comprises
notifying the A device of the acceptance of the proposed lowered Vbus voltage by the B device, prior to lowering of the Vbus voltage.

6. The method of claim 1, wherein the step of negotiating a second voltage level comprises notifying the A device non-acceptance of the proposed lowered Vbus voltage level by the B device.

7. The method of claim 1, wherein the USB connection is a USB-OTG connection, further comprising:
d) recognizing the restored Vbus voltage level as a signal that the B device is seeking to gain the host role.

8. The method of claim 1 further comprising:
d) enabling non-OTG devices serving as B devices to operate at the second lower voltage level.

9. The method of claim 2 further comprising:
d) initiating a host negotiating protocol (HNP) by the B device after the B device restores the Vbus voltage level.

10. The method of claim 1 further comprising:
e) providing a new proposed lower Vbus voltage to the B device after indicating non-acceptance of the proposed lowered Vbus voltage.

11. The method of claim 10 further comprising:
f) repeating new proposed lower Vbus voltage to the B device until acceptance is indicated by the B device.

12. A device comprising:
a) a processor coupled to a universal series bus (USB) bus including a Vbus, data lines D+ and D−, and a ground line;
b) a storage device coupled to the processor and providing software executable by the processor;
c) a power supply capable of supplying Vbus with at least two different voltage levels;
d) control circuits coupled to the processor and the USB bus, the control circuits responsive to the processor for controlling the transfer of information to and from the USB device, wherein the processor is configured to:
(i) send a message via the USB bus notifying a transceiver of a proposed lowered Vbus voltage for saving power, and
(ii) receiving a response from the transceiver indicating acceptance or non-acceptance of the lowered Vbus voltage.

13. The device of claim 12 wherein the USB connection is a universal series bus on-the-go (USB-OTG) connection, and wherein the processor is further configured to:
(iii) receive a signal from the transceiver after lowering of the Vbus voltage, wherein the signal indicates the transceiver desires to serve as the USB host.

14. The device of claim 12 wherein the USB connection is a USB-OTG connection, and wherein the processor is further configured to:
(iii) suspend activity on the USB bus and engage in a host negotiation protocol (HNP) with the transceiver.

15. The device of claim 12 wherein the processor is further configured to:
(iii) provide the transceiver with a message proposing a new lowered Vbus voltage after the transceiver indicates non-acceptance of the proposed lowered Vbus voltage.

16. The device of claim 12 wherein the processor is further configured to:
(iii) determine whether the transceiver has accepted a new proposed lowered Vbus voltage, and if not, continue to provide new proposed lowered Vbus voltages until the transceiver accepts the new proposed lowered Vbus voltage.

17. A device, comprising:
a) a processor coupled to a universal series bus (USB) bus including a Vbus, data lines D+ and D−, and a ground line;
b) a storage device coupled to the processor and providing software executable by the processor;
c) control circuits coupled to the processor and the USB bus, the control circuits responsive to the processor for controlling the transfer of information to and from the USB device, wherein the processor is configured to:
(i) receive a message from a transceiver via the USB bus notifying the USB device of a proposed lowered Vbus voltage for saving power, and
(ii) providing a response to the transceiver indicating acceptance or non-acceptance of the proposed lowered Vbus voltage.

18. The device of claim 17 wherein the USB connection is a universal series bus on-the-go (USB-OTG) connection, and wherein the processor is further configured to:
(iii) send a signal to the transceiver after lowering of the Vbus voltage, wherein the signal indicates the USB device desires to serve as host in the USB-OTG connection.

19. The device of claim 17 wherein the processor is further configured to:
(iii) receive from the transceiver a new proposed lowered Vbus voltage after indicating non-acceptance of the proposed lowered Vbus voltage.

20. The device of claim 17 wherein the USB connection is a USB-OTG connection, and wherein the processor is further configured to:
(iii) terminate activity on the USB bus enabling the transceiver to resume the role of a host, and the USB device to resume the role of a peripheral device on the USB-OTG connection.

21. A medium, executable in a computer system, comprising:
a) program instructions for providing a first voltage level via a voltage bus (Vbus) from a first universal series bus (USB) or A device serving as host to a second USB or B device serving as a peripheral device in the USB connection; and
b) program instructions for lowering the first voltage level on the Vbus to a second or lower voltage level by the A device to save power on the USB connection.

22. The medium of claim 21 further comprising:
c) program instructions for restoring the first voltage level on the Vbus by the B device as a signal to the A device to change roles in the USB connection, where the A device becomes the peripheral device and the B device becomes the host.

23. The medium of claim 21 further comprising:
d) program instructions for exchanging roles by the A and B devices while the devices are in an active state.

24. The medium of claim 21 further comprising:
d) program instructions for sending a message to the B device by the A device informing the B device of a proposed lowered Vbus voltage.

25. The medium of claim 21 further comprising:
d) program instructions for notifying the A device of the acceptance of the proposed lowered Vbus voltage by the B device, prior to lowering of the Vbus voltage.

26. The medium of claim 21 further comprising:
d) program instructions for notifying the A device non-acceptance of the proposed lowered Vbus voltage level by the B device.

27. Apparatus, comprising:
a) means for providing a first voltage level via a voltage bus (Vbus) from a first universal series bus (USB) or A device serving as host to a second USB or B device serving as a peripheral device in a USB connection;
b) means for negotiating a second voltage level on the Vbus that is lower than the first voltage level, and
c) means for lowering the first voltage level on the Vbus to the second voltage level by the A device to save power on the USB connection.

28. The apparatus of claim 27, further comprising:
d) means for restoring the first voltage level on the Vbus by the B device as a signal to the A device to change roles, where the A device becomes the peripheral device and the B device becomes the host.

29. The apparatus of claim 27, further comprising:
d) means for recognizing the restored Vbus voltage level as a signal that the B device is seeking to gain the host role.

30. The apparatus of claim 27, further comprising:
d) means for initiating a host negotiating protocol (HNP) by the B device after the B device restores the Vbus voltage level.
